(19) United States
(12) Patent Application Publication
(10) Pub. No.: US 2010/0013755 A1
(43) Pub. Date: Jan. 21, 2010

(54) COLOR SEQUENTIAL LIQUID CRYSTAL DISPLAY AND LIQUID CRYSTAL DISPLAY PANEL DRIVING METHOD THEREOF

(75) Inventors: Shian-Jun Chiou, Taipei City (TW); Kuang-Lang Chen, Taoyuan County (TW); Wen-Chih Tai, Taoyuan County (TW); Chi-Neng Mo, Taoyuan County (TW); Chia-Lin Liu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/207,510

(22) Filed: Sep. 10, 2008

(30) Foreign Application Priority Data
Jul. 18, 2008 (TW) 97127458

(51) Int. Cl. G09G 3/36

(52) U.S. Cl. 345/102; 345/87

(57) ABSTRACT

A color sequential liquid crystal display (color-sequential-LCD) and an LCD panel driving method thereof are disclosed. By changing the arrangement of the pixel array in the LCD panel and turning on several rows of pixels in the LCD panel at the same time, so that the color sequential LCD of the present invention not only respectively reduces the scanning time of red, green and blue video data to make the liquid crystal molecules of all the pixels on the LCD panel have enough response time but also respectively increases the lighting-up time of the red, green and blue light emitting diodes of the back light module to promote the display brightness of the entire LCD panel. Therefore, the color sequential LCD of the present invention displays a single color or a full color image without the bottom color mixing phenomenon, and furthermore, the display brightness thereof can be promoted.

### CROSS-REFERENCE TO RELATED APPLICATION

This application claims the priority benefit of Taiwan application serial no. 97127458, filed on Jul. 18, 2008. The entirety of the above-mentioned patent application is hereby incorporated by reference herein and made a part of specification.

### BACKGROUND OF THE INVENTION

1. Field of the Invention

The present invention relates to a color sequential LCD, and in particular, to a color sequential LCD and an LCD panel driving method thereof which may display a single color or a full color image without a bottom color mixing phenomenon.

2. Description of Related Art

In recent years, with great advance in the fabricating techniques of electrical-optical and semiconductor devices, flat panel displays (FPDs), such as liquid crystal displays (LCDs), have been developed. Due to the advantageous features of the LCDs, for example, high space utilization efficiency, low power consumption, free radiation, and low electrical field interference, the LCDs have become the main stream in the market. It is commonly known that the LCD includes an LCD panel and a backlight module, and because the LCD panel cannot emit light by itself, it is necessary to dispose the backlight module below the LCD panel to provide a surface light source required by the LCD panel, so that the LCD may display an image for viewers.

The principle of providing a surface light to the LCD panel from the backlight module of the traditional LCD is providing a white light first, and then utilizing color filters on each of the pixels in the LCD panel to display the desired color of each pixel. In light of the above, it is necessary to dispose red (R), green (G), and blue (B) color filters at each of the pixels, which results in higher process cost and each pixel has lower light transmittance rate after light passes through the color filters.

Therefore, in recent LCDs, a light-emitting diode (LED) backlight source is utilized to replace the white light backlight source to display the color of each of the pixels. That is to say, the color mixing on the axis of space, for example, three sub-pixels of red, green and blue colors mixed together within a view angle of the human being, is replaced by utilizing the LED as the backlight source and mixing the three sub-pixels colors on the axis of time (rapidly switching the red, green and blue colors of the LED backlight source within a range of time of visual retention with the human being).

For example, if displaying a dynamic image is at 60 frames per second, it will take 180 images per second as to rapidly switch the R, G, B colors of the LED backlight source on the axis of time, i.e. each frame period is 5.56 ms. Such implementation is so called a color sequential method, improves the light transmittance rate of each of the pixels and requires no color filters disposed at each of the pixels in the LCD panel.

However, although the LCD driven by utilizing the color sequential method can improves the light transmittance rate of each of the pixels, a bottom color mixing phenomenon occurs, i.e. another color appears below the entire displayed frame, when the LCD is used to display an image frame with a single color. The main reason causing the bottom color mixing phenomenon is that the response time of liquid crystal molecules in the current market is not short enough. The backlight module of the LCD driven by the color sequential method controls the LEDs to light up in the color order of R, G, and B, so as to provide the surface light source required by the LCD panel. Therefore, if the LCD is used to display an entirely red frame, a green frame appears at the bottom thereof; if the LCD is used to display an entirely green frame, a blue frame appears at the bottom thereof; and if the LCD is used to display an entirely blue frame, a red frame appears at the bottom thereof.

The below description accompanied with drawings are provided to more specifically describe the process of the bottom color mixing phenomenon. FIG. 1 is a system block diagram illustrating an LCD 100 driven by utilizing a color sequential method. FIG. 2 is a lighting-up timing diagram of a backlight module 105 in the LCD 100 driven by utilizing a color sequential method. Please refer to FIGS. 1 and 2. In FIG. 2, the lighting-up timing diagram includes a timing of a vertical synchronous signal Vsync, a timing of a start pulse signal STV, scan timing RS of red video data VD, a response timing RLC of the red video data VD, a lighting-up timing RL of a red LED R, a response timing GLC of green video data VD, a scan timing GS of the green video data VD, a lighting-up timing GL of a green LED G, a scan timing BS of blue video data VD, a response timing BLC of the blue video data VD, and a lighting-up timing BL of a blue LED B.

Moreover, T_{RS}, T_{RLC} and T_{RL} shown in FIG. 2 respectively represent the required scan time of the red video data VD, the required response time of the red video data VD, and the lighting-up time of the red LED R. T_{GS}, T_{GLC} and T_{GL} respectively represent the required scan time of the green video data VD, the required response time of the green video data VD, and the lighting-up time of the green LED G. T_{BS}, T_{BLC} and T_{BL} respectively represent the required scan time of the blue video data VD, and the lighting-up time of the blue LED B.

Then, referring to FIGS. 1 and 2, when the LCD 100 driven by utilizing the color sequential method is used to display an entirely red frame, the timing controller 101 respectively provides the start pulse signal STV and the entirely red video data VD to a gate driver 103 and a source driver 102. Thereby, the gate driver 103 outputs a scan signal SS sequentially to turn on each row of pixels (not shown) in the LCD panel 104, i.e. the scan timing RS of the red video data VD in FIG. 2.

After that, the turned-on pixels receive the data signals DS provided by the source driver 102 correspondingly, so that the liquid crystal molecules are polarized to a fixed position. Thereafter, when all the pixels in an LCD panel 104 are polarized to a light transparent position (i.e. the response timing RLC of the red video data VD), the timing controller 101 controls the red LED R in the backlight module 105 to light up immediately, i.e. the lighting-up timing RL of the red LED R in FIG. 2, so that the LCD panel 104 may display the entirely red frame.

Then, the timing controller 104 provides the start pulse signal STV and an entirely black video data VD respectively to the gate driver 103 and the source driver 102. Thereby, the gate driver 103 outputs a scan signal SS sequentially to turn on each row of pixels (not shown) in the LCD panel 104, i.e. the scan timing GS of the green video data VD in FIG. 2. Afterwards, the turned-on pixels receive the data signals DS provided by the source driver 102 correspondingly, so that the liquid crystal molecules are polarized to a fixed position, i.e. the response timing GLC of the green video data VD. Then, when all the liquid crystal molecules of the pixels in the LCD panel 104 are polarized to a non-light-transparent position, the timing controller 101 then controls the green LED G in the backlight module 105 to light up, i.e. the lighting-up timing GL of the green LED G in FIG. 2.

However, because the response time of the liquid crystal molecules of all the pixels in the LCD panel 104 in the current market is not short enough, the green LED G is lighted up before the liquid crystal molecules of the pixels at the bottom of the LCD panel 104 are polarized to the non-light-transparent position, and therefore a green frame appears at the bottom of the entirely red frame displayed by the LCD panel 104. So far, the process of the bottom color mixing phenomenon is explained.

Based on the above descriptions, persons of ordinary skill in the art should be able to deduce that when the LCD 100 is used to display an entirely green frame, a blue frame appears at the bottom thereof due to the bottom color mixing phenomenon, and deduce that when the LCD 100 is used to display an entirely blue frame, a red frame appears at the bottom thereof, and therefore detailed descriptions are omitted herein. Accordingly, the LCD 100 provides poor display quality when the LCD 100 driven by utilizing the color sequential method is utilized to display the single color image. Similarly, the LCD 100 has the same problem when the LCD 100 driven by utilizing the color sequential method is utilized to display a full color image.

### SUMMARY OF THE INVENTION

In light of the above, the present invention is directed to a color sequential liquid crystal display (color sequential LCD) and an LCD panel driving method for eliminating a bottom color mixing phenomenon, occurring when the color sequential LCD displays a single color or a full color image, by changing the arrangement of the pixel array in an LCD panel and turning on several rows of pixels in the LCD panel at the same time.

The color sequential LCD provided by the present invention includes an LCD panel, a gate driver, and a source driver. The LCD panel has an M×N resolution and at least M×N pixels, wherein the M×N pixels include K groups of pixels, and M, N, and K are positive integers. The gate driver is electrically connected to the LCD panel and has N gate channels. The gate channel turns on the K rows of pixels at the same time after the gate channel receives K start pulse signals, wherein each row of pixels includes at least M pixels.

The source driver is electrically connected to the LCD panel and has K×M source channels, wherein the K×M source channels includes K groups of source channels, and the K groups of source channels are electrically connected to the K groups of pixels correspondingly. After the source driver receives a video data, the source driver utilizes the source channels to respectively output a data voltage to all the pixels in the rows of pixels turned on simultaneously by the gate driver.

According to one embodiment of the present invention, the gate driver includes K gate driving units respectively having N/K gate channels. After the gate driving units receive K start pulse signals correspondingly, the gate driving units respectively utilize their own gate channels to output a scan signal sequentially, so that the K rows of pixels in the LCD panel are turned on at the same time.

According to one embodiment of the present invention, the i^{th} group of pixels in the K groups of pixels is disposed at the intersection of the i^{th} group of source channels and the gate channels of the i^{th} gate driving unit, wherein i is smaller than or equal to K.

According to one embodiment of the present invention, the color sequential LCD further includes a timing controller electrically connected to the gate driver and the source driver for generating the K start pulse signals and the video data respectively to the gate driver and the source driver.

According to one embodiment of the present invention, the color sequential LCD further comprises a backlight module disposed below the LCD panel for providing a surface light source required by the LCD panel.

According to one embodiment of the present invention, the LCD panel includes an optically compensated birefringence (OCB) LCD panel, a twisted nematic (TN) LCD panel, or a super twisted nematic (STN) LCD panel.

From another point of view, the present invention provides an LCD panel driving method, wherein the LCD panel has an M×N resolution and at least M×N pixels, and M and N are positive integers. The LCD panel driving method provided by the present invention includes steps as follows. First of all, the M×N pixels are divided into K groups of pixels, wherein K is a positive integer. Then, K start pulse signals are provided to turn on the K rows of pixels in the LCD panel at the same time. Finally, a corresponding data voltage is provided to all the pixels in the K rows of pixels turned on simultaneously by the K start pulse signals.

According to the present invention, by changing the arrangement of the pixel array in the LCD panel and turning on several rows of pixels in the LCD panel at the same time, the color sequential LCD not only respectively reduces the scanning time of red, green and blue video data to make the liquid crystal molecules of all the pixels in the LCD PANEL have enough response time, but also respectively increases the lighting-up time of red, green and blue light emitting diodes (LEDs) of the backlight module to promote the display brightness of the entire LCD panel. Therefore, the color sequential LCD of the present invention may display a single color or a full color image without the bottom color mixing phenomenon, and furthermore, the display brightness of the color sequential LCD can be promoted.

To make the above and other objectives, features, and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram illustrating a liquid crystal display (LCD) driven by utilizing a color sequential method.

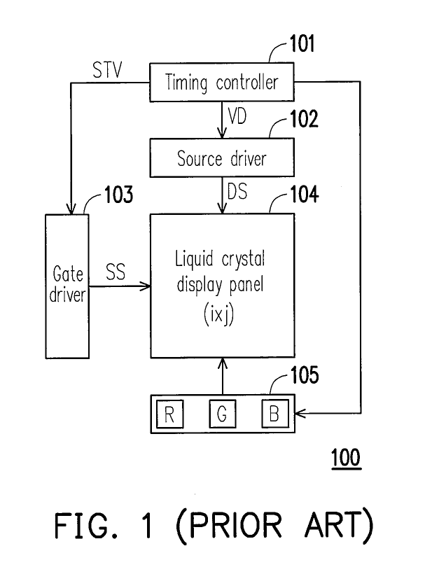

FIG. 2 is a lighting-up timing diagram of the backlight module in the LCD display driven by utilizing the color sequential method.

FIG. 3 is a system block diagram illustrating a color sequential LCD according to one embodiment of the present invention.

FIG. 4 is a lighting-up timing diagram illustrating of the backlight module in the color sequential LCD of FIG. 3.

FIG. 5 is a system block diagram illustrating a color sequential LCD according to another embodiment of the present invention.

FIG. 6 is a schematic flowchart illustrating an LCD panel driving method according to one embodiment of the invention.

### DESCRIPTION OF EMBODIMENTS

The present invention is directed to solving the issue that a bottom color mixing phenomenon occurs when a conventional color sequential liquid crystal display (color sequential LCD), driven by utilizing a color sequential method, displays a single color or a full color image. The technical features and the efficacy of the present invention are described in detail below for a reference of persons of ordinary skill in the arts.

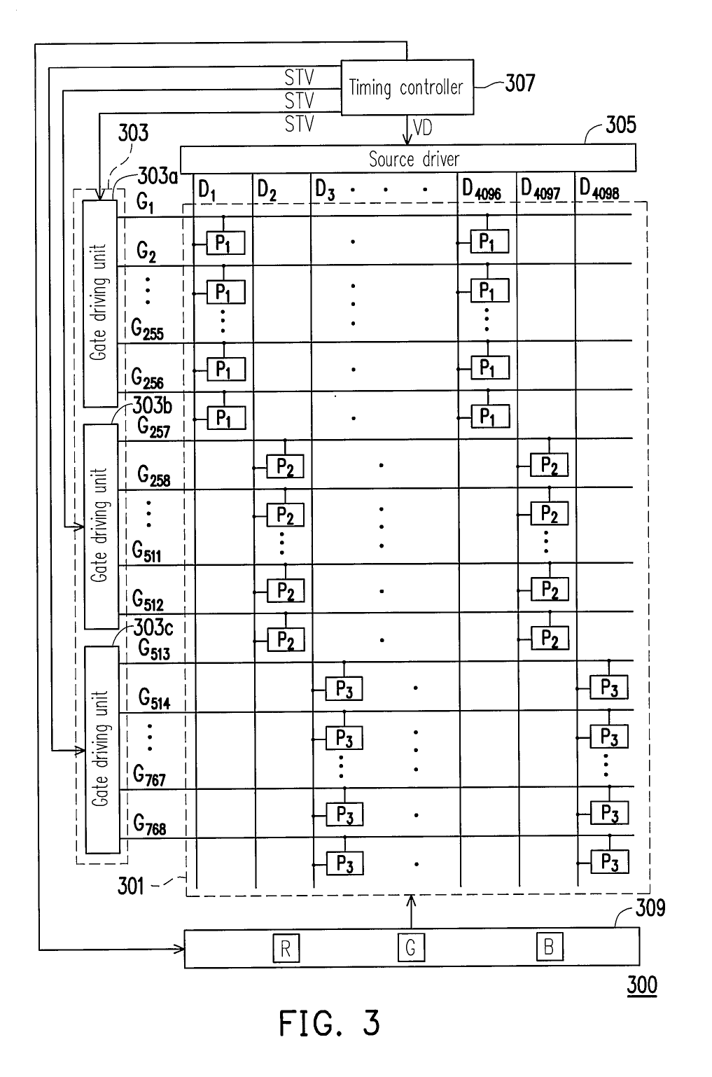

FIG. 3 is a system block diagram illustrating a color sequential LCD 300 according to one embodiment of the present invention. Referring to FIG. 3, the color sequential LCD 300 includes an LCD 301, a gate driver 303, a source driver 305, a timing controller 307, and a backlight module 309. According to the present embodiment, the LCD panel 301 has an M×N resolution and at least M×N pixels, wherein the M×N pixels includes K groups of pixels, and M, N, and K are positive integers.

To more specifically describe the spirit of the present invention, it is assumed that the LCD panel 301 has a 1366×768 resolution, so that the LCD panel 301 has at least 1366×768 pixels and the pixels are divided into 3 groups of pixels P₁˜P₃. In the present embodiment, the LCD panel 301 is an optically compensated birefringence (OCB) LCD panel. However, the LCD panel 301 may be a twisted nematic (TN) LCD panel or a super twisted nematic (STN) LCD panel.

Based on the above-mentioned, the gate driver 303 is electrically connected to the LCD panel 301 and has 768 gate channels G₁˜G₇₆₈. The gate driver 303 turns on the 3 rows of pixels at the same time after the gate driver 303 receives three start pulse signals STV provided by the timing controller 307, wherein each row of pixels includes at least 1366 pixels.

The source driver 305 is electrically connected to the LCD panel 301 and has 3×1366 source channels D₁˜D₄₀₉₈, wherein the source channels D₁˜D₄₀₉₈ are divided into 3 groups of source channels, and the 3 groups of source channels are electrically connected to the 3 groups of pixels correspondingly. After the source driver 305 receives a video data VD provided by the timing controller 307, the source driver 305 utilizes the source channels D₁˜D₄₀₉₈ to respectively output a data voltage to all the pixels in the 3 rows of pixels turned on simultaneously by the gate driver 303.

The backlight module 309 is disposed below the LCD panel 301, and the backlight module 309 has red, green, and blue light emitting diodes (LEDs) R, G, B disposed therein. The backlight module 309 is controlled by the timing controller 307 and provides red, green and blue lights serving as a surface light source required by the LCD panel 301.

In the present embodiment, the (3j+1)^{th} source channel in the source channel D₁˜D₄₀₉₈ are the same group of source channels, i.e. the source channels D₁, D₄, D₇, . . . , and D₄₀₉₆; the (3j+2)^{th} source channel in the source channel D₁˜D₄₀₉₈ are the same group of source channels, i.e. D₂, D₅, D₈, . . . , and D₄₀₉₇; and the (3j+3)^{th} source channel in the source channel D₁˜D₄₀₉₈ are the same group of source channels, i.e. D₃, D₆, D₉, . . . , and D₄₀₉₈. j is a positive integer smaller than or equal to 1365.

Furthermore, the gate driver 303 includes 3 gate driving units 303a˜303c inside. The gate driving units 303a˜303c respectively include 256 gate channels, i.e. gate channels G₁˜G₂₅₆, G₂₅₇˜G₅₁₂, and G₅₁₃˜G₇₆₈. After the gate driving units 303a˜303c respectively receive a start pulse signal STV correspondingly, the gate driving units respectively utilize their own gate channels G₁˜G₂₅₆ [symbol] G₂₅₇˜G₅₁₂ [symbol] G₅₁₃˜G₇₆₈ to output a scan signal sequentially, so that the 3 rows of pixels in the LCD panel are turned on at the same time.

Furthermore, the pixel group P₁ is disposed at the intersection of the source channel group D₁, D₄, D₇, . . . , and D₄₀₉₆ and the gate channels G₁˜G₂₅₆ of the gate driving unit 303a; the pixel group P₂ is disposed at the intersection of the source channel group D₂, D₅, D₈, . . . , and D₄₀₉₇ and the gate channels G₂₅₇˜G₅₁₂ of the gate driving unit 303b; and the pixel group P₃ is disposed at the intersection of the source channel group D₃, D₆, D₉, . . . , and D₄₀₉₈ and the gate channels G₅₁₃˜G₇₆₈ of the gate driving unit 303c.

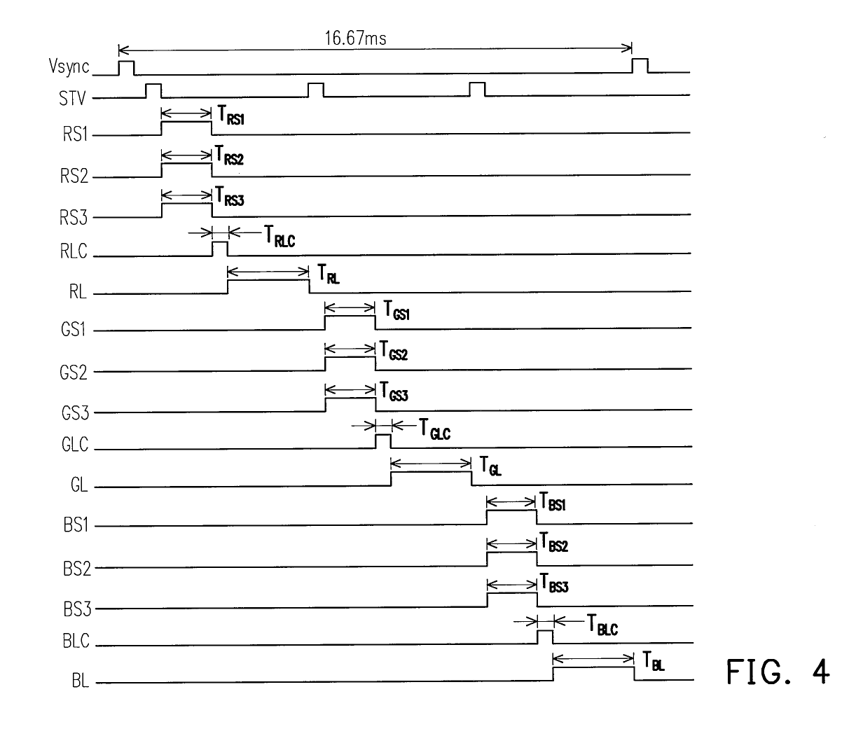

Up to this point, the below descriptions accompanied with FIG. 4 are provided to explain why the system structure of the color sequential LCD 300 can eliminate the bottom color mixing phenomenon occurring when the conventional color sequential LCD displays the signal color or the full color image.

FIG. 4 is a lighting-up timing diagram of the backlight module 309 in the color sequential LCD 300. Please refer to FIGS. 3 and 4. The lighting-up sequence diagram includes a timing of a vertical synchronous signal Vsync, a timing of a start pulse signal STV, scan timings RS₁˜RS₃ of a red video data VD, a response timing RLC of the red video data VD, a lighting-up timing RL of the red LED R, scan timings GS₁˜GS₃ of a green video data VD, a response timing GLC of the green video data VD, a lighting-up timing GL of the green LED G, scan timings BS₁˜BS₃ of blue video data VD, a response timing BLC of the blue video data VD, and a lighting-up timing BL of the blue LED B.

Moreover, T_{RS1}˜T_{RS3} [symbol] T_{RLC} and T_{RL} shown in FIG. 4 respectively represent the scan time required for scanning the red video data VD, the response time required by the red video data VD, and the lighting-up time of the red LED R. T_{GS1}˜T_{GS3} [symbol] T_{GLC} and T_{GL} respectively represents the scan time required for scanning the green video data VD, the response time required by the green video data VD, and the lighting-up time of the green LED G. T_{BS1}˜T_{BS3} [symbol] T_{BLC} and T_{BL} respectively represent the scan time required for scanning the blue video data VD, the response time required by the blue video data VD and the lighting-up time of the blue LED B.

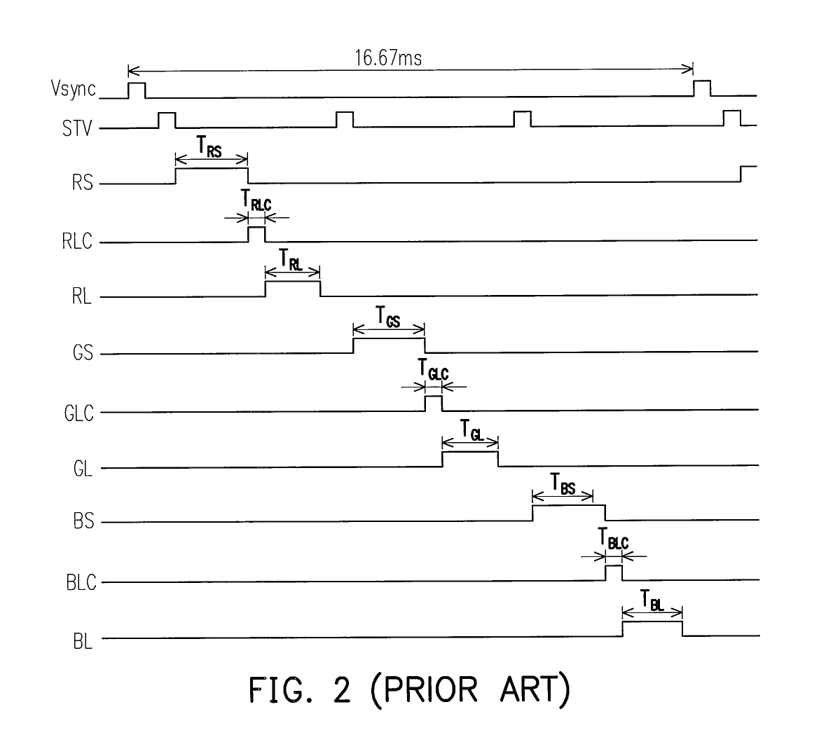

It should be noted that, in the present embodiment, the scan time T_{RS1}˜T_{RS3} required for scanning the red video data VD is one-third of the scan time T_{RS} required for scanning the red video data VD in the prior art shown by FIG. 2; the scan time T_{GS1}˜T_{GS3} required for scanning the green video data VD is one-third of the scan time T_{GS} required by the green video data VD in the prior art shown by FIG. 2; and the scan time T_{BS1}˜T_{BS3} required by the blue video data VD is one-third of the scan time T_{BS} required for scanning the blue video data VD in the prior art shown by FIG. 2. The response time T_{RLC} [symbol] T_{GLC} [symbol] T_{BLC} required by the red, green, blue video data VD may be adjusted depending on the types of the liquid crystal molecules, and the liquid crystal molecules are not limited to the aforesaid OCB type liquid crystal molecules.

Then, please refer to FIGS. 3 and 4, when the color sequential LCD 300 is used to display an entirely red frame, the timing controller 307 provides a start pulse signal STV and an entirely red video data VD respectively to the gate driving units 303a˜303c inside the gate driver 303 and to the source driver 305. Thereby, the gate channels G₁˜G₂₅₆ [symbol] G₂₅₇˜G₅₁₂ [symbol] G₅₁₃˜G₇₆₈ respectively owned by the gate driving units 303a˜303c output a scan signal sequentially to turn on the three rows of pixels in the LCD panel 301, i.e. the scan timings RS₁˜RS₃ of the red video data VD in FIG. 4.

The turned-on pixels receive data signals provided by the source driver 305 correspondingly, so that the liquid crystal molecules are polarized to a fixed position. After that, when all the pixels in the LCD panel 301 are polarized to a light transparent position, the timing controller 307 controls the red LED R in the backlight module 309 to light up immediately, i.e. the lighting-up timing RL of the red LED R in FIG. 4, so that the LCD panel 301 may display the entirely red frame.

Thereafter, the timing controller 307 further provides a start pulse signal STV and an entirely black video data VD respectively to the gate driving units 303a˜303c in the gate driver 303 and to the source driver 305. Thereby, the gate channels G₁˜G₂₅₆ [symbol] G₂₅₇˜G₅₁₂ [symbol] G₅₁₃˜G₇₆₈ respectively owned by the gate driving units 303a˜303c output the scan signal sequentially to turn on the three rows of pixels in the LCD panel 301, i.e. the scan timings GS₁˜GS₃ of the green video data VD in FIG. 4.

Afterwards, the turned-on pixels receive the data signals provided by the source driver 305 correspondingly, so that the liquid crystal molecules are polarized to a fixed position. Nevertheless, although the response time of all liquid crystal molecules of all the pixels P₁˜P₃ in the LCD panel 301 is not short enough, because the gate driver 303 of the present embodiment may turn on three rows of pixels in the LCD panel 301 at the same time, two-thirds of scan time of the red video data VD is reduced, so that all liquid crystal molecules of the pixels P₁˜P₃ in the LCD panel 301 have enough response time to be polarized to a non-light-transparent position.

Then, even the time controller 307 controls the green LED G in the backlight module 309 to light up, i.e. the lighting-up timing GL of the green LED G in FIG. 4, the present invention is prevented from the bottom color mixing phenomenon occurring when the conventional color sequential LCD displays the single color or the full color image.

Based on the above descriptions, persons of ordinary skill in the art may deduce that when the color sequential LCD 300 is used to display an entirely green frame or an entirely blue frame, the present invention is prevented from the bottom color mixing phenomenon occurring when the conventional color sequential LCD displays the single color or the full color image, and therefore detailed descriptions are omitted. Besides, because the scan time required for scanning the red/green/blue video data VD is reduced, the lighting-up time of the red/green/blue LED R, G, B of the backlight module 309 are increased, and thereby the display brightness of the LCD panel 301 may be promoted.

However, it should be noted that, the total number of the pixels in the LCD panel 301 is not limited to M×N pixels. That is to say, according to actual demands, the total number of the pixels in the LCD panel 301 can be increased to be 3×M×N pixels, and the same efficacy of the present invention may also be achieved in this way.

Furthermore, the pixels in the LCD panel 301 are not limited to 3 groups of pixels P₁˜P₃. That is to say, according to actual demands, all the pixels in the LCD panel 301 may be divided into more than 3 groups of pixels. Such implementation only requires an increase in the number of the gate driving units in the gate driver 303, and may be deduced by persons of ordinary skill in the art based on the teachings of the above embodiments, and therefore detailed descriptions are omitted.

Therefore, when there are more gate driving units additionally disposed in the gate driver 303, the gate driver 303 may turn on more rows of pixels in the LCD panel 301 at the same time, so that the scan time of red/green/blue video data are reduced more, and thereby the lighting-up time of the red/green/blue LED R, G, B of the backlight module 309 may be increased further.

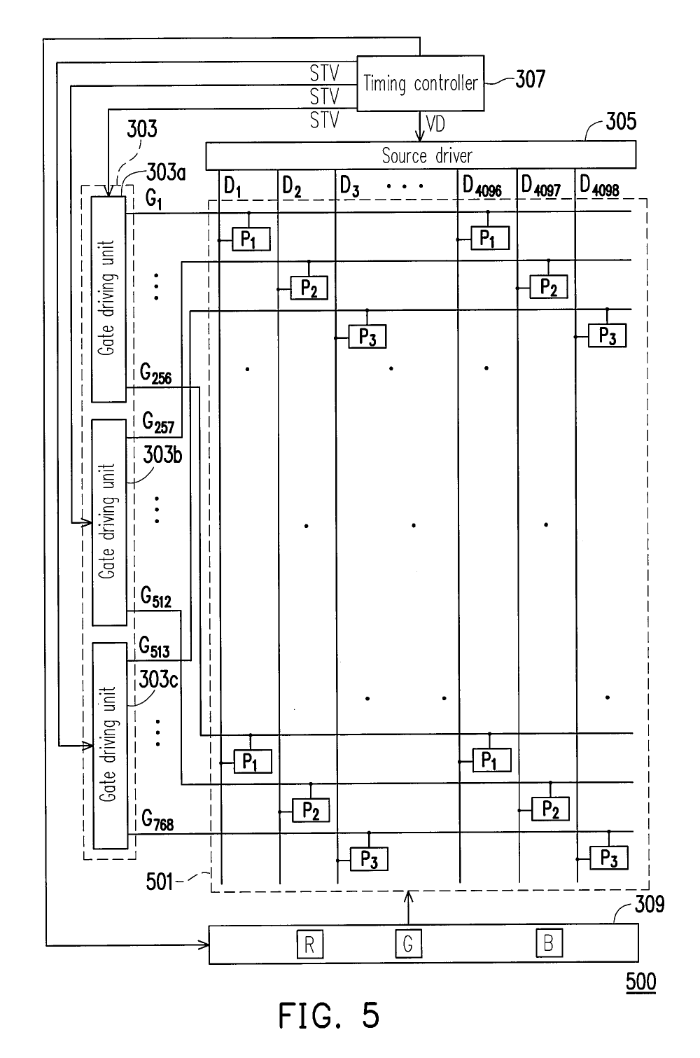

Furthermore, the arrangement of the pixel array in the LCD panel 301 of the present embodiment is not limited to the type disclosed by FIG. 3. FIG. 5 is a system block diagram illustrating a color sequential LCD 500 according to another embodiment of the present invention. Referring to FIGS. 3 and 5, the main difference between the color sequential LCD 500 and the color sequential LCD 300 lies in that the pixel array of an LCD panel 501 of the color sequential LCD 500 and the pixel array of the LCD panel 301 of the color sequential LCD 300 have different arrangements. Nevertheless, the color sequential LCD 500 may achieve the same efficacy as the color sequential LCD 300. Therefore, detailed descriptions are omitted.

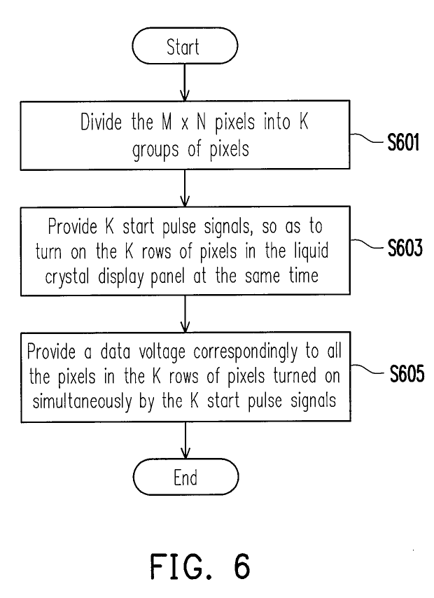

Based on the disclosure of the aforesaid embodiments, an LCD panel driving method is described below as a reference for persons of ordinary skill in the art. FIG. 6 is a schematic flowchart illustrating an LCD panel driving method according to one embodiment of the invention. Referring to FIG. 6, the LCD panel driving method according to the present embodiment is suitable for the LCD panel with the M×N resolution, and the LCD panel has at least M×N pixels.

The LCD panel driving method according to the present embodiment includes steps as follows. First of all, in a step S601, the M×N pixels are divided into K groups of pixels, wherein K is a positive integer. Then, in step S603, K start pulse signals are provided to turn on the K rows of pixels in the LCD panel at the same time. Finally, in a step S605, a corresponding data voltage is provided to all the pixels in the K rows of pixels turned on simultaneously by the K start pulse signals.

In light of the above, by using the LCD panel driving method of the present embodiment, multiple rows of pixels in the LCD panel may be turned on at the same time, so that the scan time of video data can be reduced, and thereby the liquid crystal molecules of all the pixels in the LCD panel have enough response time, and so that the present invention is prevented from the bottom color mixing phenomenon when the color sequential LCD displays the single color or the full color image.

In summary, according to the present invention, by changing the arrangement of the pixel array in the LCD panel and turning on several rows of pixels in the LCD panel at the same time, the color sequential LCD not only respectively reduces the scanning time of the red, green and blue video data to make the liquid crystal molecules of all the pixels in the LCD PANEL have enough response time, but also respectively increases the lighting-up time of red, green and blue light emitting diodes (LEDs) of the backlight module to promote the display brightness of the entire LCD panel. Therefore, the color sequential LCD of the present invention may display the single color or the full color image without the bottom color mixing phenomenon, and furthermore, the display brightness of the color sequential LCD can be promoted.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A liquid crystal display, comprising:
a liquid crystal display panel having an M×N resolution and at least M×N pixels, wherein the M×N pixels include K groups of pixels, and M, N, and K are positive integers;
a gate driver, electrically connected to the liquid crystal display panel and having N gate channels for turning on the K rows of pixels in the liquid crystal display panel at the same time after receiving K start pulse signals, wherein each row of pixels includes at least M pixels; and
a source driver, electrically connected to the liquid crystal display panel and having K×M source channels, wherein the K×M source channels include K groups of source channels, the K groups of source channels are electrically connected to the K groups of pixels correspondingly, and after the source driver receives a video data, the source driver utilizes the K×M source channels to respectively output a data voltage to all the pixels in the K rows of pixels turned on simultaneously by the gate driver.

2. The liquid crystal display according to claim 1, wherein the gate driver includes K gate driving units respectively having N/K gate channels, and after the K gate driving units receive K start pulse signals correspondingly, the K gate driving units respectively utilize their own gate channels to output a scan signal sequentially, so that the K rows of pixels in the liquid crystal display panel are turned on at the same time.

3. The liquid crystal display according to claim 2, wherein the i^{th} group of pixels is disposed at the intersection of the i^{th} group of source channels and the N/K gate channels of the i^{th} gate driving unit, and i is smaller than or equal to K.

4. The liquid crystal display according to claim 1, further comprising a timing controller, electrically connected to the gate driver and the source driver for generating the K start pulse signals and the video data respectively to the gate driver and the source driver.

5. The liquid crystal display according to claim 1, further comprising a backlight module, disposed below the liquid crystal display panel for providing a surface light source required by the liquid crystal display panel.

6. The liquid crystal display according to claim 1, wherein K is an integer no smaller than and equal to 3.

7. The liquid crystal display according to claim 1, wherein the liquid crystal display panel comprises an optically compensated birefringence (OCB) liquid crystal display panel, a twisted nematic (TN) liquid crystal display panel, or a super twisted nematic (STN) liquid crystal display panel.

8. The liquid crystal display according to claim 1, wherein the liquid crystal display is a color sequential liquid crystal display.

9. A liquid crystal display panel driving method, the liquid crystal display panel having an M×N resolution and at least M×N pixels, wherein M and N are positive integers, and the liquid crystal display panel driving method includes steps as follows:
dividing the M×N pixels into K groups of pixels, wherein K is a positive integer;
providing K start pulse signals to turn on the K rows of pixels in the liquid crystal display panel at the same time; and
providing a corresponding data voltage to all the pixels in the K rows of pixels turned on simultaneously by the K start pulse signals.

10. The liquid crystal display panel driving method according to claim 9, wherein K is an integral no smaller than and equal to 3.
